(19) United States
(12) Patent Application Publication
(10) Pub. No.: US 2015/0098142 A1
(43) Pub. Date: Apr. 9, 2015

(54) LENS BARREL AND IMAGE PICKUP APPARATUS

(71) Applicant: CANON KABUSHIKI KAISHA, Tokyo (JP)

(72) Inventor: Mitsuhiro Izumi, Yokohama-shi (JP)

(21) Appl. No.: 14/501,565

(22) Filed: Sep. 30, 2014

(30) Foreign Application Priority Data
Oct. 9, 2013 (JP) 2013-212195
Oct. 9, 2013 (JP) 2013-212222

(51) Int. Cl. G02B 7/02; G02B 7/10

(52) U.S. Cl. CPC G02B 7/023; G02B 7/10
USPC 359/817

(57) ABSTRACT

A retractable lens barrel includes a first main bar, a second main bar, a fixed barrel including the first main bar, a linear movement barrel including a second main bar and movable in an optical axis direction, a leaf spring configured to adjust decentering of the second main bar relative to the first main bar in a plane orthogonal to the optical axis, and leaf springs configured to adjust a tilt of the second main bar relative to the first main bar in the optical axis direction by pushing the linear movement barrel onto the fixed barrel at a plurality of positions in a plane orthogonal to the optical axis. The first main bar and the second main bar are configured to guide a lens frame holding a lens. After the second main bar is moved closer to an object than the first main bar, tilt adjustment by the leaf springs is completed following decentering adjustment by the leaf spring.

### BACKGROUND OF THE INVENTION

1. Field of the Invention

The present invention relates to a lens barrel and an image pickup apparatus.

2. Description of the Related Art

In a retractable lens barrel, a tilt and shift of the lens barrel needs to be prevented so as to maintain the optical performance at image capturing. Japanese Patent Laid-open No. 2010-266582 discloses a positioning apparatus that maintains the accuracies of adjusting decentering in a plane orthogonal to an optical axis and a tilt relative to the optical axis by pushing a holder that holds an optical element onto a guide shaft through a forcing unit.

However, the positioning apparatus disclosed in Japanese Patent Laid-open No. 2010-266582 requires a long guide support for the holder, which is not suitable for a retractable structure, whereas a short guide support may reduce the accuracy of adjusting at least one of the decentering and the tilt. When an external force larger than an elastic force of the holder is applied on the lens barrel to be held, the holder may fail to hold the lens barrel and cause a tilt and shift thereof. Alternatively, a higher elastic force to enhance a bearing force against the external force may increase a driving load to move a lens.

### SUMMARY OF THE INVENTION

The present invention provides a retractable lens barrel and an image pickup apparatus that are capable of maintaining the accuracies of adjusting decentering and a tilt between two guides that guide a holder of an optical element. The present invention also provides a retractable lens barrel and an image pickup apparatus that are capable of maintaining the accuracy of adjusting at least one of the decentering and the tilt without increasing a driving load on the holder of the optical element.

A lens barrel according to an aspect of the present invention includes a first guide, a second guide configured to protrude toward an object relative to the first guide in an optical axis direction in a transition from a retracted state to a photographing state, a lens holding unit having one holder held by the first guide and another holder held by the second guide, a shift adjuster configured to adjust a shift between the first guide and the second guide in a direction orthogonal to the optical axis in the photographing state, a tilt adjuster configured to adjust a tilt between the first guide and the second guide in the photographing state, and a lock member configured to determine a positional relationship between the first guide and the second guide after the shift adjustment and the tilt adjustment.

A lens barrel according to another aspect of the present invention includes a first guide, a second guide configured to protrude toward an object relative to the first guide in an optical axis direction in a transition from a retracted state to a photographing state, a lens holding unit having one holder held by the first guide and another holder held by the second guide, a lock member configured to determine a positional relationship between the first guide and the second guide, and a forcing member. The lock member pushes the lens barrel holding the second guide by a force larger than a force applied by the forcing member in the photographing state.

### BRIEF DESCRIPTION OF THE DRAWINGS

FIGS. 1A and 1B are partially sectional views of a lens barrel in a protruded state (photographing state) according to this embodiment of the present invention.

FIG. 2 is a partially transparent front view of the lens barrel illustrated in FIGS. 1A and 1B.

FIGS. 3A and 3B are partially sectional views of the lens barrel illustrated in FIGS. 1A and 1B.

FIG. 4 is an exploded diagram of a fixed barrel and a cam barrel illustrated in FIGS. 1A and 1B.

FIG. 5 is a schematic cross-sectional view of a linear movement key of a linear movement barrel illustrated in FIGS. 1A and 1B.

FIGS. 6A to 6C illustrate the configuration of a wedge illustrated in FIGS. 3A and 3B.

FIGS. 7A and 7B are schematic sectional views for explaining a retracting operation of the lens barrel illustrated in FIGS. 1A and 1B.

FIGS. 8A to 8D are exploded diagrams of the fixed barrel and the cam barrel when the lens barrel illustrated in FIGS. 1A and 1B retracts and protrudes.

FIGS. 9A and 9B are flowcharts of the retracting operation of the lens barrel illustrated in FIGS. 1A and 1B.

FIGS. 10A and 10B are flowcharts of a protruding operation of the lens barrel illustrated in FIGS. 1A and 1B.

FIGS. 11A and 11B are diagrams for explaining a forcing order according to the embodiment.

FIGS. 12A and 12B are diagrams for explaining a forcing order different from that of the embodiment.

FIGS. 13A and 13B are graphs for explaining the effects of the configurations illustrated in FIGS. 11A and 11B and FIGS. 12A and 12B.

FIGS. 14A and 14B are schematic sectional views for explaining the effect of the operation illustrated in FIG. 10B.

FIGS. 15A and 15B are exemplary graphs of a force amplification ratio by a wedge.

### DESCRIPTION OF THE EMBODIMENTS

A lens barrel according to this embodiment of the present invention will be described below. The lens barrel houses an image pickup optical system for forming an optical image of an object and is fixed in an image pickup apparatus such as a digital video camera. The image pickup apparatus includes an image sensor that photoelectrically converts the optical image formed by the image pickup optical system.

The lens barrel includes a fixed barrel 1, a cam ring 2, a linear movement barrel 3, a lens frame 4, a lens 5, a first main bar 6b, a second main bar 6a, a sub bar 6c, a feed screw 7, a motor 8, and other members. A dashed and single-dotted line OA denotes an optical axis of the lens 5.

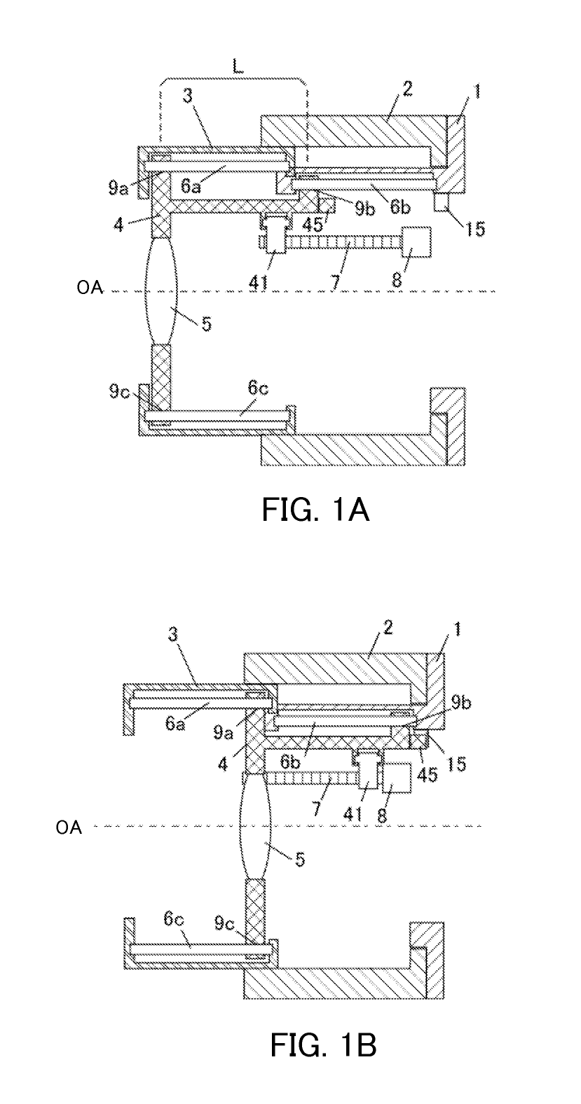

FIGS. 1A and 1B are schematic sectional views including the optical axis of the image pickup optical system of the lens frame 4 of the lens barrel, and illustrate a state in which the linear movement barrel 3 is protruded. This state allows image capturing while the lens 5 is held highly accurately, and is also referred to as a “photographing state” below. A retracted state in which the linear movement barrel 3 is retracted is a non photographing state or a state that enables image capturing while the lens 5 is not required to be held highly accurately. In FIGS. 1A and 1B, the left side is the object side and the right side is an image plane side, and this arrangement also applies to other sectional views unless mentioned otherwise. FIG. 1A illustrates a state in which the lens frame 4 is protruded (moved to the object side), and FIG. 1B illustrates the lens frame 4 is retracted (moved to the image plane side). The lens barrel according to this embodiment is retractable in this manner, which enables downsizing to enhance the portability.

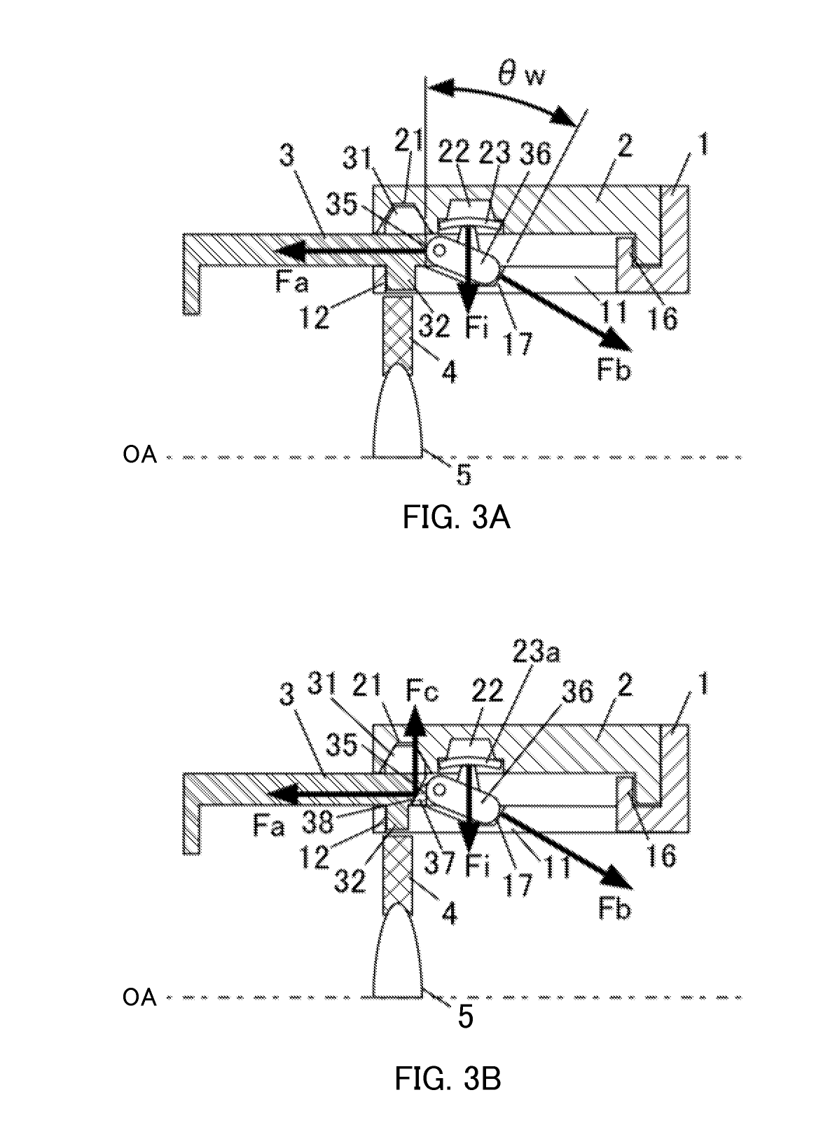

The fixed barrel 1 is a fixing member provided with the cam ring 2 rotatably around the optical axis. FIG. 3A is a partially sectional view of the lens barrel in the photographing state including the optical axis. The fixed barrel 1 includes the first main bar (first guide, first guide shaft) 6b and a straight groove 11 extending in the optical axis direction.

The first main bar 6b has a cylindrical shape made of, for example, stainless steel, and extends in the optical axis direction with its both ends held by the fixed barrel 1. In this embodiment, the guide shaft is used as the guide, but a key structure (including a key and a key groove) may be used instead.

As described later, three straight grooves 11 are provided in this embodiment and engaged with linear movement keys (linear movement portions) 32 that move along the respective straight grooves 11. One of the linear movement keys 32 serves as a decentering adjusting unit and is also referred to as a linear movement key (first linear movement portion) 32a below so as to be distinguished from the other two linear movement keys (second linear movement portions) 32b and 32c. The straight groove 11 engaged with the linear movement key 32a is also referred to as a first groove so as to be distinguished from the straight grooves 11 as second grooves engaged with the linear movement keys 32b and 32c.

The cam ring 2 has a substantially cylindrical shape, includes a cam groove 21, and rotates being supplied with drive power by a motor not illustrated.

The linear movement barrel 3 has a substantially cylindrical shape and is disposed inside the cam ring 2. The linear movement barrel 3 is a linear movement member and includes the second main bar 6a as a second guide (second guide shaft), the sub bar 6c, and a cam follower 31 that moves along the cam groove. When the cam ring 2 rotates relative to the fixed barrel 1, the cam follower 31 moves along the cam groove 21 and the linear movement barrel 3 moves relative to the fixed barrel 1 in the optical axis direction of the lens 5.

The lens frame 4 is a holder holding the lens 5 as part of the image pickup optical system and is movable in the optical axis direction so as to change the imaging state of a light ray. The lens 5 is an example of an optical element, but the optical element is not limited to a lens.

The lens frame 4 includes engagement units 9a and 9b that each have a substantially cylindrical bore shape and are respectively engaged with the second main bar 6a and the first main bar 6b. The second main bar 6a and the first main bar 6b constitute a guide unit that guides the lens frame 4. The engagement units 9a and 9b are engaged with the second main bar 6a and the first main bar 6b, leaving gaps required for sliding relative to the second main bar 6a and the first main bar 6b. The gaps may cause a tilt of the lens frame 4 with respect to the optical axis.

The engagement units 9a and 9b are separated from each other by a distance L, and the engagement unit 9a as a first guided portion is disposed closer to the object than the engagement unit 9b as a second guided portion. The gradient of the lens frame 4 with respect to the optical axis caused by the gaps tends to be smaller when the distance L is longer.

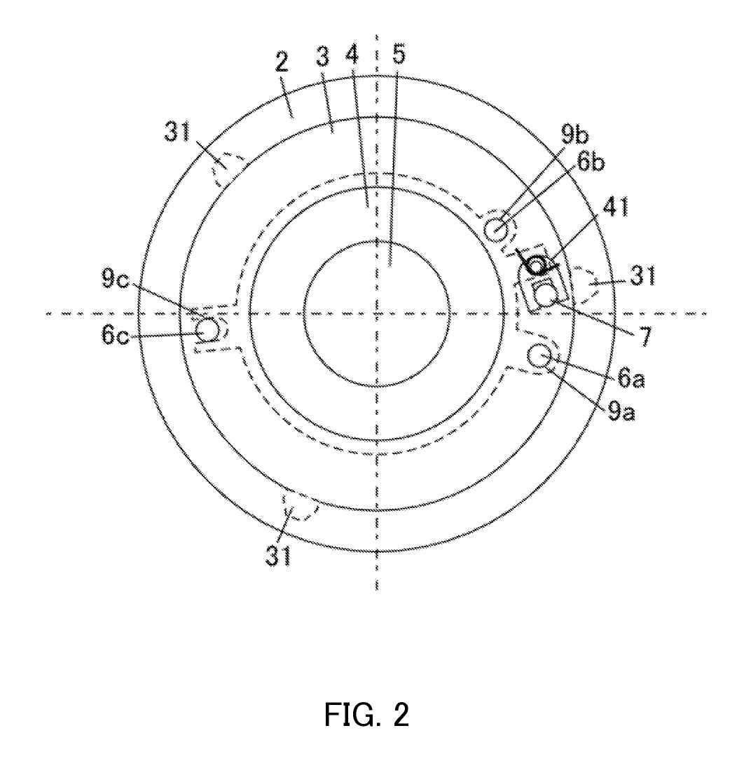

FIG. 2 is a partially transparent front view of the lens barrel viewed from the object side. As illustrated in FIG. 2, an engagement unit 9c has a U shape in the front view and is engaged with the sub bar 6c. The engagement unit 9c prevents the tilt of the lens frame 4 caused by rotation around an axis connecting the engagement units 9a and 9b. The lens frame 4 is also tilted through a change in the distance between the second main bar 6a and the first main bar 6b. Thus, in order to reduce the tilt of the lens frame 4, the distance between the second main bar 6a and the first main bar 6b needs to be maintained unchanged.

The second main bar 6a and the sub bar 6c each have a cylindrical shape made of, for example, stainless steel, extend in a direction parallel to the optical axis, and have both ends held by the linear movement barrel 3. The engagement unit 9b as the first guided portion and the engagement units 9a and 9c as the second guided portions are guided along the optical axis by the first main bar 6b, the second main bar 6a, and the sub bar 6c, respectively. In FIG. 2, the second main bar 6a is disposed off a radial direction connecting the optical axis and the center of the first main bar 6b so as to prevent an increase in size of the lens barrel in the radial direction.

There has been no retractable lens barrel that includes a single main shaft (main bar) and a sub shaft (sub bar) as guide shafts that guide the movement of a holder of an optical element. In this embodiment, this main shaft is divided into two, the first main bar 6b and the second main bar 6a, so as to achieve a retractable lens barrel. The total length of the image pickup optical system in the optical axis direction is shortened accordingly when not in use for image capturing, thereby enhancing the portability.

However, the configuration where the single main shaft is divided into the two relatively-movable main bars has a slight gap between the main bars. This gap causes decentering and inclination between the main bars when the lens frame 4 moves, which degrades the optical performance of the lens 5. This embodiment solves this problem by providing a lock unit that fixes (locks) and unfixes (unlocks) the second main bar 6a on and from the first main bar 6b and by configuring the lens frame 4 to protrude being locked by the lock unit, thereby maintaining the optical performance.

The lock unit includes the decentering adjusting unit and a tilt adjusting unit. The decentering adjusting unit adjusts the decentering of the second main bar 6a relative to the first main bar 6b in a plane orthogonal to the optical axis of the lens 5. The tilt adjusting unit pushes the linear movement barrel 3 onto the fixed barrel 1 at multiple positions in the plane orthogonal to the optical axis (at least at two positions; not necessarily in the same plane) and thereby adjusts the tilt of the second main bar 6a relative to the first main bar 6b in the optical axis direction.

In Japanese Patent Laid-open No. 2010-266582, a lens frame is pushed onto a guide bar at one point so as to adjust the decentering and the tilt, and the lens frame is locked on the guide bar after moving on the guide bar. The guide bar is fixed and thus a lens barrel is not retractable.

In this embodiment, the tilt adjusting unit pushes the linear movement barrel 3 onto the fixed barrel 1 in the plane orthogonal to the optical axis so as to adjust the tilt. Since no long component is required in the optical axis direction, the lens barrel is retractable. Although the linear movement barrel 3 is pushed onto the fixed barrel 1 at the plane in the above description, this embodiment also includes pushing at a curved surface (point contact).

In this embodiment, when the decentering adjusting unit operates, part of the tilt adjusting unit operates simultaneously. A power point position at which the tilt adjusting unit acts first is closer to the power point position of the decentering adjusting unit than a power point position at which the tilt adjusting unit acts next is. For example, the distance between the position of a force dividing block 37 to which a leaf spring 23a applies a force Fc and the position of the linear movement key 32b to which the force Fc is applied is longer than the distance between the position of a first contact surface 35 to which a leaf spring 23b applies a force Fa and the position of the linear movement key 32b to which the force Fa is applied. Thus, the tilt adjustment by the tilt adjusting unit is configured to be completed after the decentering adjustment by the decentering adjusting unit. This configuration allows the decentering adjustment accuracy and the tilt adjustment accuracy to be maintained while the lens frame 4 is moved and the optical image is formed through the lens 5, thereby preventing image blur. The use of the guide shafts enhances noise reduction compared to a mechanism in which the lens is moved only through the cam.

Next follows a description of a move unit that moves the lens frame 4. The motor 8 is fixed on the fixed barrel 1, and the feed screw 7 is fixed on an output shaft of the motor 8. A rack 41 is provided to the lens frame 4, is rotatable around an axis parallel to the optical axis, and is held so as not to move relative to the lens frame 4 in the optical axis direction. The rack 41 is engaged with the feed screw 7 and converts rotation of the feed screw 7 into movement in the optical axis direction. With this configuration, the lens frame 4 can be moved in the optical axis direction by rotation of the motor 8.

FIG. 1A illustrates the lens frame 4 positioned closer to the object. For example, assuming the lens 5 as a zooming optical element, this state is referred to as a wide-angle state. When the motor 8 rotates, as illustrated in FIG. 1B, the lens frame 4 moves away from the object and becomes a telephoto state. The amount of movement of the lens frame 4 can be detected accurately by using, for example, a stepping motor, which can count the number of pulses, as the motor 8. The absolute position of the lens frame 4 relative to the fixed barrel 1 can be corrected by providing the fixed barrel 1 with a photo-interrupter 15 as a position detecting unit and providing the lens frame 4 with a light-shielding wall 45 for position detection.

As illustrated in FIG. 3A, the fixed barrel 1 includes a bayonet unit 16 to prevent the cam ring 2 from uncoupling in the optical axis direction. The cam ring 2 is coupled to the fixed barrel 1 rotatably in a predetermined angle range with, for example, a stopper (not illustrated).

The cam groove 21 is disposed on the inner periphery of the cam ring 2 and is engaged with the cam follower 31. The cam follower 31 has a convex shape toward the outer periphery of the linear movement barrel 3. The linear movement key 32 is provided to the linear movement barrel 3 and is engaged with the straight groove 11 of the fixed barrel 1 so as to regulate rotation of the linear movement barrel 3 around the optical axis. With this configuration, when the cam ring 2 rotates, the linear movement barrel 3 moves in the optical axis direction along the locus of the cam groove 21.

In the photographing state, a leaf spring 23 that rotates around the optical axis together with the cam ring 2 bows and pushes a wedge 36 as a pushing unit with an input force Fi from near the inner periphery of the cam ring 2 toward the optical axis in a plane vertical to the optical axis. The movement of the leaf spring 23 is not limited to rotation. The wedge 36 constitutes the decentering adjusting unit and the tilt adjusting unit and fixes the distance between the second main bar 6a and the first main bar 6b in the optical axis direction.

The input force Fi pushes the linear movement barrel 3 and the fixed barrel 1 through a third contact surface 35 provided to the linear movement barrel 3 and a fourth contact surface 17 provided to the fixed barrel 1, respectively. The third contact surface 35 as a plane substantially orthogonal to the optical axis receives the lens barrel pushing force Fa. The fourth contact surface 17 is disposed such that its distance to the third contact surface 35 decreases toward a direction in which the wedge 36 is pushed by the leaf spring 23, and the fourth contact surface 17 receives a force Fb. Therefore, the wedge 36 pushed by the leaf spring 23 exerts a wedge (force-amplifying) effect. Specifically, the force pushing the third contact surface 35 and the fourth contact surface 17 can be amplified to be greater than the input force Fi applied by the leaf spring 23. For example, when the angle of the wedge is denoted by θw, the lens barrel pushing force Fa on the third contact surface 35 is given by the relationship:

Fa=Fi/tan(θw)

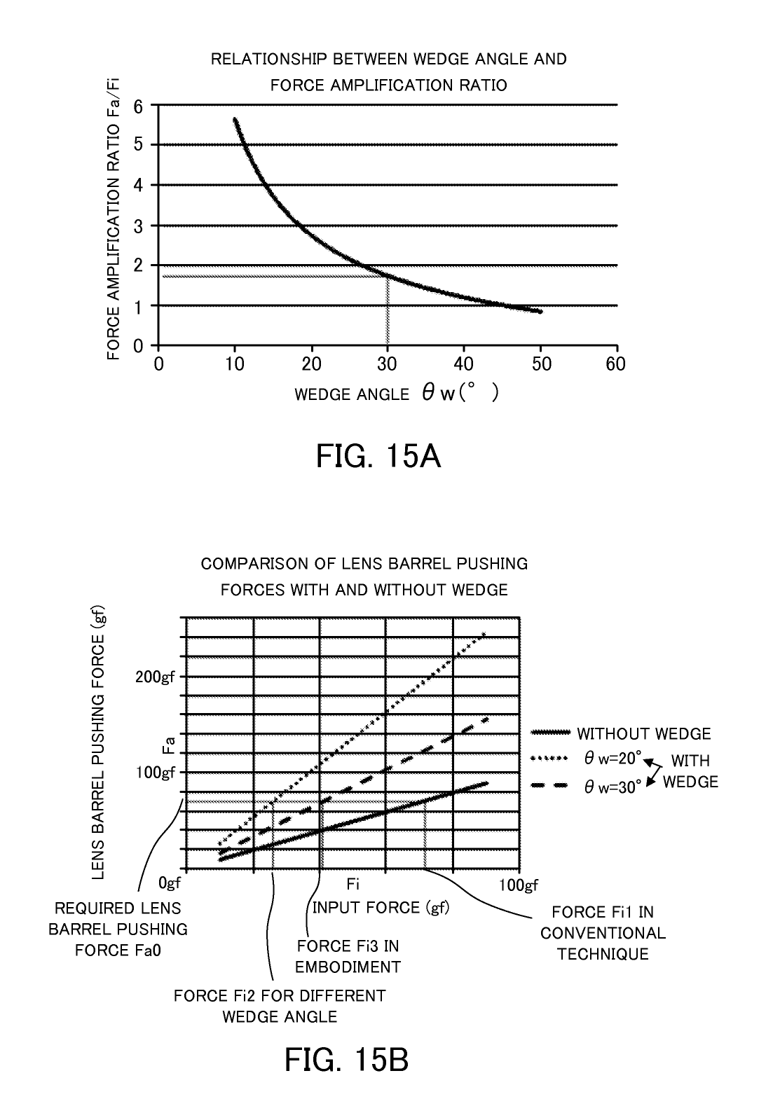

When θw<45°, the relationship Fa>Fi is held, indicating the force amplification. FIGS. 15A and 15B are graphs illustrating examples of the force amplification ratio by the wedge.

In FIG. 15A, the horizontal axis represents the angle θw (°) of the wedge, and the vertical axis represents the amplification ratio of the lens barrel pushing force Fa to the input force Fi. The amplification ratio of unity or more indicates that the force is amplified. For example, the angle θw of 10° can amplify the force Fa relative to the force Fi by 5 or more. In this embodiment, the wedge angle θw is set to 30°, and the force Fa is amplified to be approximately 1.7 times accordingly.

FIG. 15B illustrates and compares force relationships in cases with and without the wedge. The horizontal axis represents the input force Fi (gf), and the vertical axis represents the lens barrel pushing force Fa (gf). In the case without the wedge, the input force Fi corresponds to drive power by a motor or the like, and the lens barrel pushing force Fa corresponds to a force pushing the lens barrel. Since the lens barrel pushing force Fa pushes the first contact surface 35, a larger lens barrel pushing force Fa leads to a larger force for holding the linear movement barrel 3. Specifically, when the force required to hold the lens barrel is denoted by Fa0, a required lens barrel pushing force is denoted by Fi1 for the conventional technique, Fi2 for the wedge angle θw of 30°, and Fi3 for the wedge angle θw of 20. These forces satisfy the relationship:

Fi1>Fi3>Fi2

This relationship indicates that this embodiment with the wedge requires a smaller force than that required in the conventional technique. The wedge 36 will be described in detail later.

In FIGS. 3A and 3B, when the linear movement barrel 3 is pushed by the third contact surface 35, the linear movement key 32 is made contact with a second contact surface 12. The second contact surface 12 is a surface of the straight groove 11 and orthogonal to the optical axis. The second contact surface 12 in contact with the linear movement key 32a is referred to as a first surface, and the second contact surfaces 12 in contact with the linear movement keys 32b and 32c are referred to as second surfaces. In this embodiment, each second contact surface 12 is an end face on the object side, but may be a face of a block fixed on the straight groove 11.

The second contact surfaces 12 are disposed at three positions around the optical axis. In other words, as illustrated in FIGS. 1A and 1B and FIGS. 3A and 3B, the second contact surfaces 12 are disposed near an end of the second main bar 6a on the image plane side and near an end of the first main bar 6b on the object side in the optical axis direction. The tilt of the linear movement barrel 3 relative to the fixed barrel 1 can be adjusted by making the linear movement key 32 contact with the second contact surface 12. Since the fixed barrel 1 has the first main bar 6b and the linear movement barrel 3 has the second main bar 6a, a relative tilt between the second main bar 6a and the first main bar 6b can also be adjusted and maintained in parallel. This configuration improves the accuracy of holding the lens frame 4 in the photographing state.

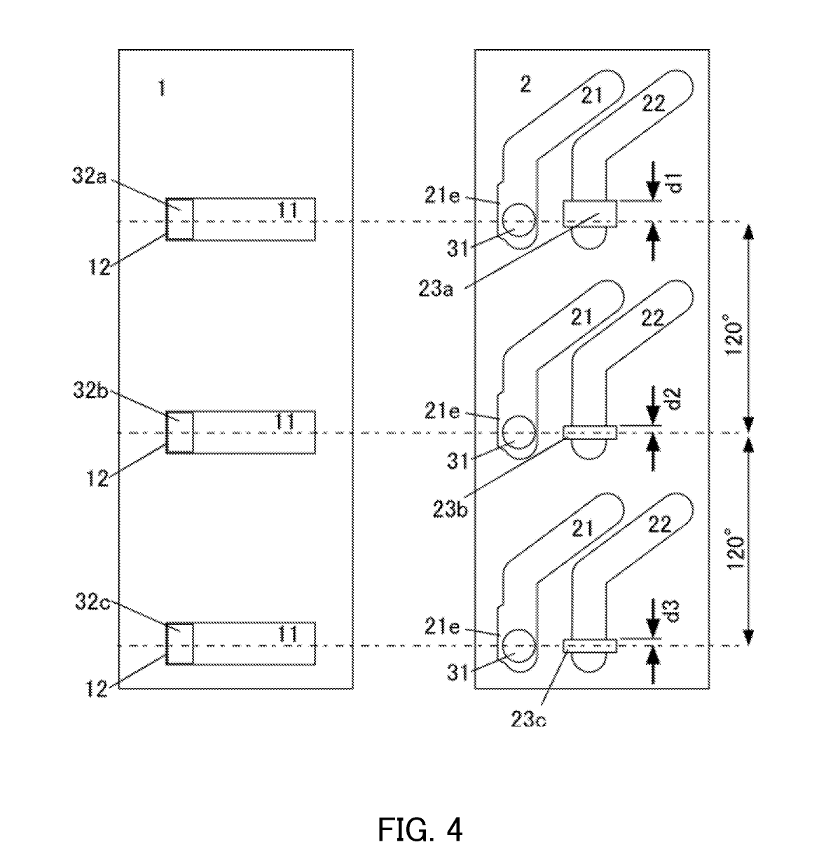

FIG. 4 is a circumferentially exploded diagram of the fixed barrel 1 and the cam ring 2.

The fixed barrel 1 includes the three straight grooves 11 circumferentially at substantially 120° intervals. Similarly, the straight grooves 11 have the three linear movement keys 32 (individually denoted by 32a to 32c in FIG. 4) inserted therein. This configuration allows the linear movement barrel 3 to move relative to the fixed barrel 1 while maintaining the decentering with respect to the optical axis within the range of the gaps. The leaf springs 23 (individually denoted by 23a to 23c in FIG. 4) as the tilt adjusting units act to cause the linear movement keys 32 to make contact with the second contact surfaces 12, thereby adjusting the tilt.

The cam grooves 21 are disposed circumferentially at substantially 120° intervals, and the cam followers 31 are disposed at the same angle positions as those of the linear movement keys 32 in this embodiment. However, the cam followers 31 may be disposed at different angle positions. In order to avoid interference between the cam grooves 21 and the cam followers 31 near the positions where the linear movement keys 32 are in contact with the second contact surfaces 12, the cam grooves 21 each are provided with a retreat portion 21e. In other words, the cam groove 21 has a wider width when the linear movement barrel 3 is at a protruded position than when the linear movement barrel 3 is at a retracted position. When the linear movement barrel 3 is being protruded along the locus of the cam groove 21, a smaller gap set between the cam groove 21 and the cam follower 31 improves the positioning accuracy. On the other hand, in the photographing state, the interference between the cam groove 21 and the cam follower 31 needs to be avoided so as to accurately position the linear movement barrel 3 and the fixed barrel 1 relative to each other. However, when there is a large gap between the cam groove 21 and the cam follower 31, the retreat portion 21e might not be provided.

The three leaf springs 23 that rotate with the cam ring 2 are disposed at substantially the same angle positions as the linear movement keys 32. In this embodiment, the leaf spring (first forcing member) 23a and the leaf springs (second forcing members) 23b and 23c have different widths in the circumferential direction of the cam ring 2; a circumferential directional width d1 of the leaf spring 23a is wider than widths d2 and d3 of the respective leaf springs 23b and 23c (d1>d2≈d3). In contrast, the three wedges 36 have the same shape. The leaf spring 23a is the decentering adjusting unit and also part of the tilt adjusting unit. Although the leaf spring 23a serves as the decentering adjusting unit and the tilt adjusting unit, the tilt adjustment is only completed when the adjustment by the leaf springs 23b and 23c is completed. For this reason, the leaf spring 23a starts pushing the wedge 36 before the leaf springs 23b and 23c in a transition from the non photographing state to the photographing state. The order of the pushing will be described later.

FIG. 3A illustrates a section of the lens barrel at the position of the leaf spring 23b or 23c. FIG. 3B illustrates a section of the lens barrel at the position of the leaf spring 23a. In FIG. 3B, the third contact surface 35 is provided to the force dividing block 37 having a right-angle section. The slope of the force dividing block 37 is in contact with the linear movement barrel 3 through a fifth contact surface 38. The force dividing block 37 is provided to the straight groove 11, has the third contact surface 35, and divides a force on the third contact surface 35 into a force in direction vertical to the optical axis and a force in the optical axis direction. FIGS. 3A and 3B illustrate a first position at which the wedge 36 is pushed by the leaf spring 23 and made contact with the fixed barrel 1.

Accordingly, the force Fi applied by the leaf spring 23a has components of the force Fa parallel to the optical axis and the force Fc orthogonal to the optical axis and departing from the optical axis. A vertically downward force acting on the force dividing block 37 to balance the force Fc is omitted in FIGS. 3A and 3B. The force Fc decenters the linear movement barrel 3 relative to the fixed barrel 1 in a direction orthogonal to the optical axis.

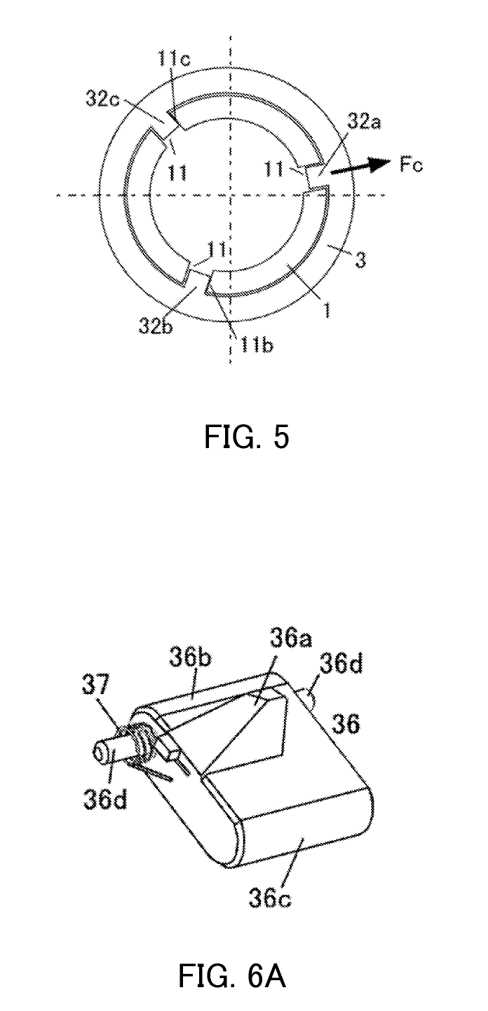

FIG. 5 is a diagram of a plane orthogonal to the optical axis viewed from the object side, illustrating part of the fixed barrel 1 and the linear movement barrel 3 that shows the relationship between the straight grooves 11 and the linear movement keys 32. As illustrated in FIG. 5, the force Fc acting at the position of the linear movement key 32a pushes the linear movement keys 32b and 32c onto walls (sidewall) 11b and 11c serving as the first contact surfaces (pushes the linear movement keys 32b and 32c to one side). The decentering is adjusted through the movement of a single member, but may be adjusted through the movement of a plurality of members.

While the linear movement keys are pushed to one side, the walls 11b and 11c are formed such that the linear movement barrel 3 is placed concentrically with the fixed barrel 1 without decentering. This configuration allows a relative decentering between the fixed barrel 1 and the linear movement barrel 3 to be adjusted through the action of the force Fc, thereby improving the positioning accuracy. The configuration also improves interval accuracy between the first main bar 6b and the second main bar 6a. That is, the linear movement keys 32b and 32c are made contact with the walls 11b and 11c as the first contact surfaces through the action of the leaf spring (first forcing member) 23a as the decentering adjusting unit, thereby adjusting the decentering.

In this manner, the first main bar 6b and the second main bar 6a have improved accuracies both in a decentering direction orthogonal to the optical axis and in a parallel direction to the optical axis, thereby maintaining a high optical accuracy even when the lens frame 4 is moved.

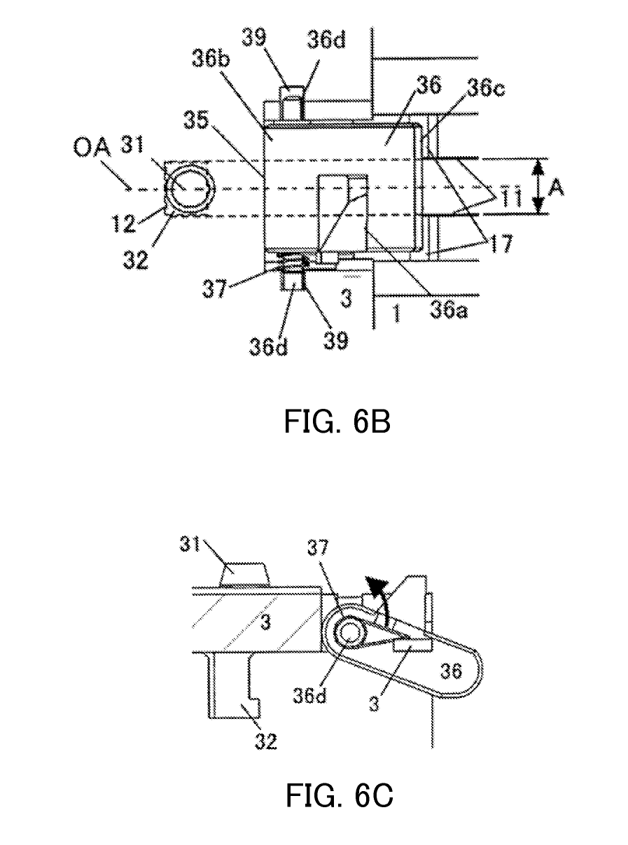

Next follows a detailed description of the wedge 36 with reference to FIGS. 6A to 6C.

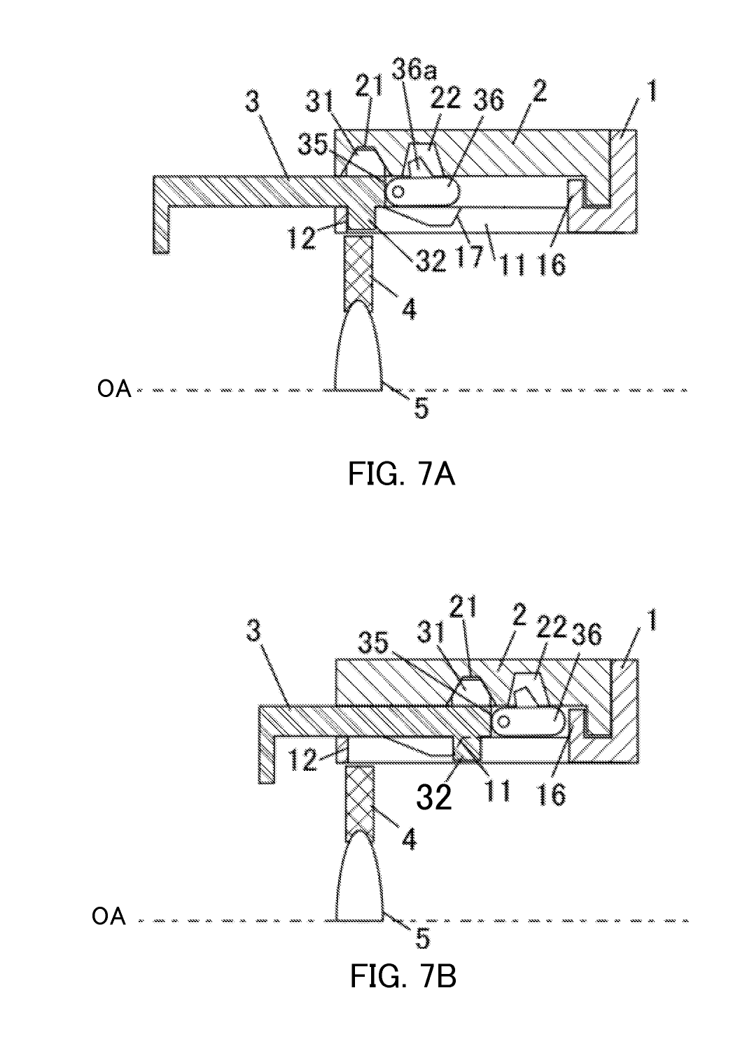

FIG. 6A is a perspective diagram of the wedge 36. Reference numeral 36a denotes a protrusion pushed by the leaf spring 23. Reference numeral 36b denotes a curved surface (first curved surface) that makes contact with the linear movement barrel 3 through the third contact surface 35. Reference numeral 36c denotes a curved surface (second curved surface) that makes contact with the fixed barrel 1 through the fourth contact surface 17. Reference numeral 36d denotes a rotating shaft that allows the wedge 36 to rotate around the linear movement barrel 3. In place of the rotating shaft 36d provided to the wedge 36, a shaft may be provided to the linear movement barrel 3 and a through-hole for the shaft may be provided to the wedge 36. The rotating shaft 36d is provided with a torsion spring 37. Although the torsion spring 37 serves as a reset unit that resets the wedge 36 in the first position illustrated in FIGS. 3A and 3B to a second position illustrated in FIG. 7, the reset unit is not limited to the torsion spring 37.

FIG. 6B is a plan view of the linear movement barrel 3 and the wedge 36. The rotating shaft 36d is roughly held with gaps by a rough guide 39 provided to the linear movement barrel 3 and is prevented from moving significantly in the optical axis direction. This configuration enables the wedge 36 to move with the linear movement barrel 3 in the optical axis direction.

FIG. 6C is a side view of the linear movement barrel 3 and the wedge 36. The wedge 36 receives a force applied by the torsion spring 37 to rotate in an arrow direction around the rotating shaft 36d. This rotational force is set to be sufficiently smaller than the force Fi applied by the leaf spring 23. In the photographing state, the wedge 36 pushed by the leaf spring 23 is pushed toward the inner periphery of the lens barrel. In contrast, when the force applied by the leaf spring 23 is released, the rotational force of the torsion spring 37 rotates the wedge 36 toward the outer periphery.

Next follows a description of the relationship between the fourth contact surface 17 and the second contact surface 12. In the photographing state, the fourth contact surface 17 is in contact with the wedge 36. As illustrated in FIGS. 3A and 3B, the fourth contact surface 17 has the shape of a cutout of the straight groove 11. As illustrated in FIG. 6B, a region A is defined by walls of the straight groove 11. The fourth contact surface 17 is disposed being separated by the region A. This configuration enables the linear movement barrel 3 to move without being interfered by the linear movement key 32 in the region A. As illustrated in FIG. 6B, as a surface at which the linear movement key 32 is in contact with the fixed barrel 1, the second contact surface 12 is disposed in the region sandwiched by the walls of the straight groove 11. Thus, the fourth contact surface 17 and the second contact surface 12 do not overlap each other, viewed in the optical axis direction.

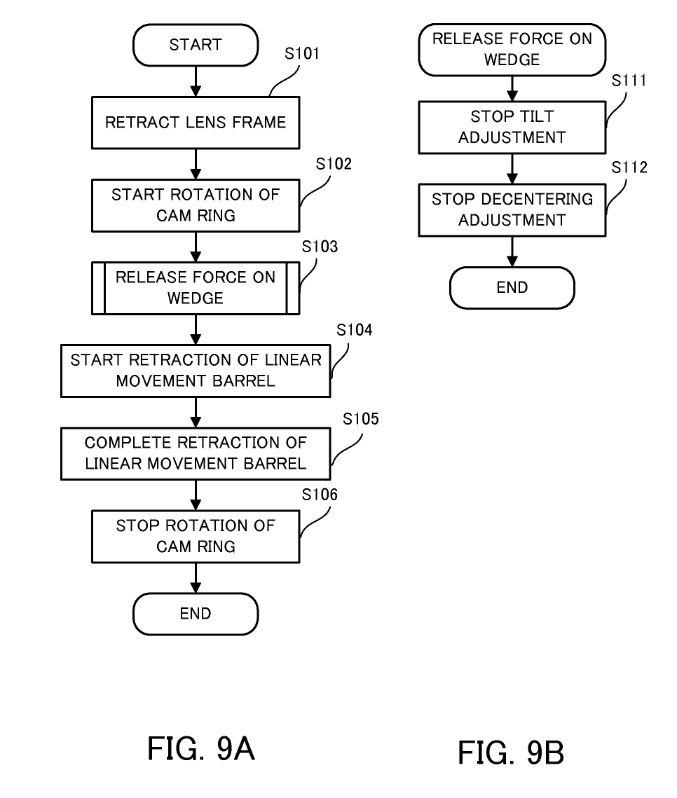

Next follows a description of a retracting operation in a transition from the photographing state to the non photographing state. FIG. 9A is a flowchart in the transition from the photographing state to the non photographing state, and “S” denotes a step. Each step may be realized as a program configured to cause a controller (not illustrated) constituted by a microcomputer and the like to implement the function of the step. This also applies to the other flowcharts.

First at S101, the lens frame 4 is retracted. The lens frame 4 positioned closer to the object when the linear movement barrel 3 moves to become the retracted state would block the movement of the linear movement barrel 3. To avoid this, as illustrated in FIG. 1B, the lens frame 4 is moved to the image plane side before the linear movement barrel 3 moves. The lens frame 4 is moved smoothly because the two main bars are locked by the lock unit.

Next at S102, the cam ring 2 is started to rotate, and at S103, the rotation of the cam ring 2 releases a force on the wedge 36. The release of the force on the wedge 36 will be described in detail later.

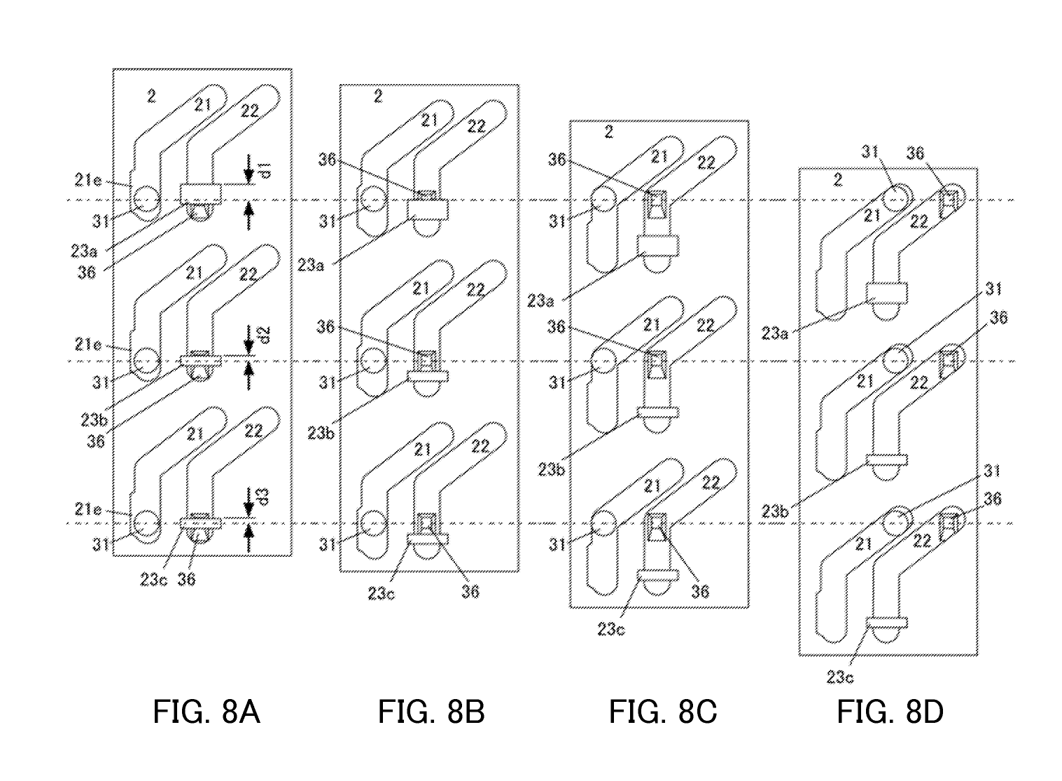

FIGS. 8A to 8D are exploded diagrams of the cam ring 2. FIG. 8A illustrates the photographing state, and the retracting operation sequentially changes the state as illustrated in FIGS. 8A to 8D. When the force on the wedge 36 is released at S103, the cam ring 2 becomes a state illustrated in FIG. 8C. The cam follower 31 has not been moved in the optical axis direction. As illustrated by the arrow in FIG. 6C, the wedge 36 is rotated by the torsion spring 37 toward the outer periphery of the lens barrel, substantially centering around the rotating shaft 36d. As a result, the cam ring 2 becomes a state illustrated in FIG. 7A. A protrusion 36a of the wedge 36 enters into a space given by a retreat groove 22 of the cam ring 2. Consequently, the cam ring 2 and the wedge 36 overlap each other when viewed in the optical axis direction. FIGS. 7A and 7B illustrate the second position in which the wedge 36 is not pushed by the leaf spring 23 and is not in contact with the fixed barrel 1. The wedge 36 is rotatably movable between the first position illustrated in FIGS. 3A and 3B and the second position illustrated in FIGS. 7A and 7B. The movement is not limited to the rotation.

At S104, the cam ring 2 rotates further, the cam follower 31 is moved along the cam groove 21, and the linear movement barrel 3 is moved toward the image plane.

At S105, the linear movement barrel 3 is moved to a predetermined position and completes the retracting operation, leaving the cam ring 2 in a state illustrated in FIG. 8D. Whether the linear movement barrel 3 has been moved to the predetermined position can be determined by, for example, counting the number of rotations of a motor that uses the cam ring 2 as a rotational drive source. FIG. 7B illustrates this retracted state.

At S106, the cam ring 2 stops rotating, and the retracting operation ends.

Next follows a detailed description of the operation of releasing the force on the wedge 36 at S103 with reference to FIG. 9B.

At S111, forces applied by two of the three wedges 36 are released. At S111, the cam ring 2 becomes a state illustrated in FIG. 8B in which the leaf springs (second forcing members) 23b and 23c do not push the wedges 36. However, the leaf spring 23a still pushes the wedge 36. As described above, the wedges 36 at the three positions have been applying forces in the optical axis direction so as to adjust the tilt of the linear movement barrel 3 relative to the fixed barrel 1. Thus, since the forces applied by two of the wedges 36 are released, the tilt is not adjusted any more.

At S112, the cam ring 2 becomes the state illustrated in FIG. 8C. The leaf spring 23a has been pushing the wedge 36 as described above so as to adjust decentering between the fixed barrel 1 and the linear movement barrel 3. Thus, in the state illustrated in FIG. 8C in which the force applied by the leaf spring 23a is released, the decentering is not adjusted. In this manner, the forces applied by the wedges 36 are released.

In this manner, the transition from the protruded state to the retracted state is completed, and the total length of the lens barrel in the optical axis direction is shortened accordingly.

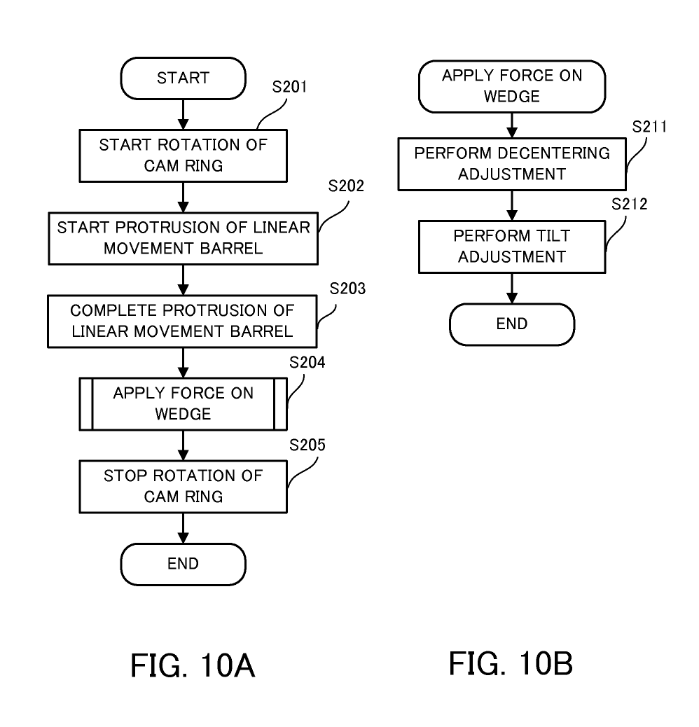

Next follows a description of the opposite transition from the retracted state to the protruded state. FIG. 10A is a flowchart of the operation from the retracted state to the protruded state.

At S201, the cam ring 2 starts rotating. At this stage, the cam grooves 21 and the cam followers 31 are arranged in the relationship illustrated in FIG. 8D. At S202, in response to the rotation of the cam ring 2, the linear movement barrel 3 starts protruding. At S203, the cam grooves 21 and the cam followers 31 become arranged in the relationship illustrated in FIG. 8C, and the linear movement barrel 3 becomes protruded closest to the object. At S204, as described later, the forces applied by the wedges 36 act to adjust the decentering and tilt of the linear movement barrel 3 relative to the fixed barrel 1. At S205, the cam grooves 21 and the cam followers 31 become the protruded state illustrated in FIG. 8A, and the rotation of the cam ring 2 stops.

Next follows a description of a force applied on the wedge 36 with reference to FIG. 10B.

At S211, in the state illustrated in FIG. 8B, the wedge 36 is pushed only by the leaf spring 23a that adjusts the positions of the second main bar 6a and the sub bar 6c relative to the first main bar 6b in a plane orthogonal to the optical axis. In this state, the wedge 36 is pushed and the forces Fa and Fc are generated as illustrated in FIG. 3B. In FIG. 5, the linear movement barrel 3 is pushed onto the fixed barrel 1 only through the linear movement key 32a pushed onto the second contact surface 12. The second contact surface 12 is not pushed by the linear movement keys 32b and 32c with no force generated yet. Thus, the tilt of the linear movement barrel 3 relative to the fixed barrel 1 is not adjusted, and there is a possibility that the linear movement keys 32b and 32c are not in contact with the second contact surface 12 and slightly separated from each other. On the other hand, the decentering is adjusted through the linear movement keys 32b and 32c being pushed onto the walls 11b and 11c by the force Fc.

At S212, as illustrated in FIG. 8A, the leaf springs 23a, 23 b, and 23c as the tilt adjusting unit that adjusts the tilt of the second main bar 6a and the sub bar 6c relative to the first main bar 6b in the optical axis direction all apply forces. In other words, the linear movement keys 32a, 32b, and 32c at three positions are pushed onto the second contact surface 12, and the tilt of the linear movement barrel 3 relative to the fixed barrel 1 is adjusted. As described above, after the second main bar 6a and the sub bar 6c as the second guides are protruded to the object side, the leaf spring 23a that serves as the decentering adjusting unit and the tilt adjusting unit acts, and then the leaf springs 23b and 23c complete the tilt adjustment.

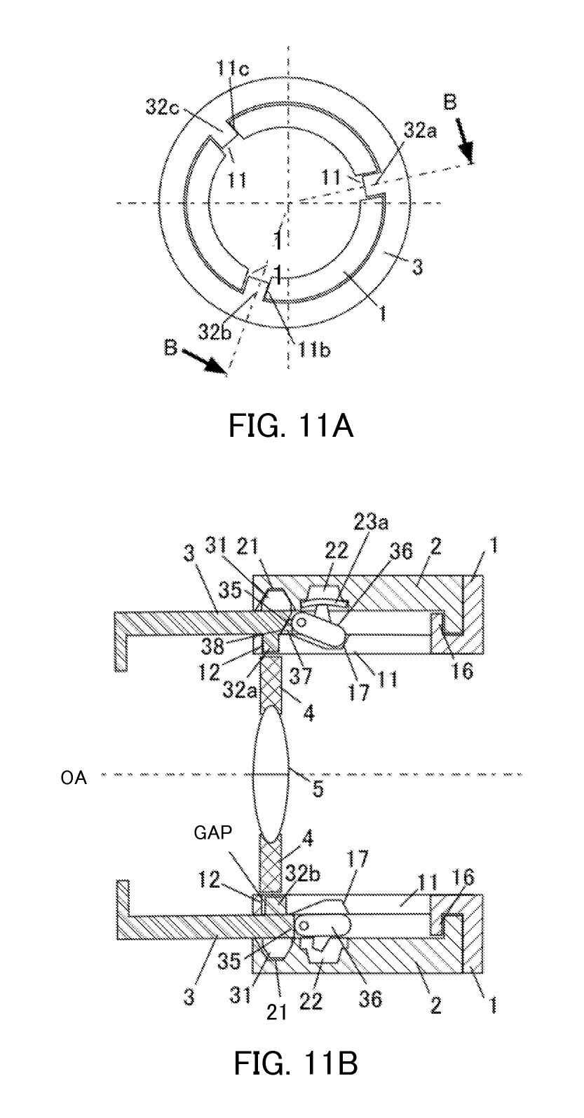

FIGS. 11A and 11B illustrate the state of the lens barrel when S211 in FIG. 10B is completed.

FIG. 11A is a cross-sectional view of the linear movement key 32. The linear movement keys 32b and 32c are pushed onto the walls 11b and 11c without gaps, and thus the decentering of the linear movement barrel 3 relative to the fixed barrel 1 in a plane orthogonal to the optical axis is adjusted.

FIG. 11B is a sectional view along line B-B in FIG. 11A. The linear movement key 32a is pushed onto the second contact surface 12 without gaps, while the linear movement keys 32b and 32c are not pushed onto the second contact surface 12, thereby generating gaps. In FIG. 11B, although not illustrated, the linear movement key 32c is in the same state as the linear movement key 32b. In other words, the linear movement barrel 3 is tilted relative to the fixed barrel 1 in the optical axis.

Next, in order to adjust the generated tilt, the leaf springs 23b and 23c, not illustrated in FIGS. 11A and 11B, act on the wedges 36, and the linear movement keys 32b and 32c is pushed onto the second contact surface 12. This adjustment is achievable relatively easily by directly applying force near the linear movement keys 32b and 32c through the wedges 36.

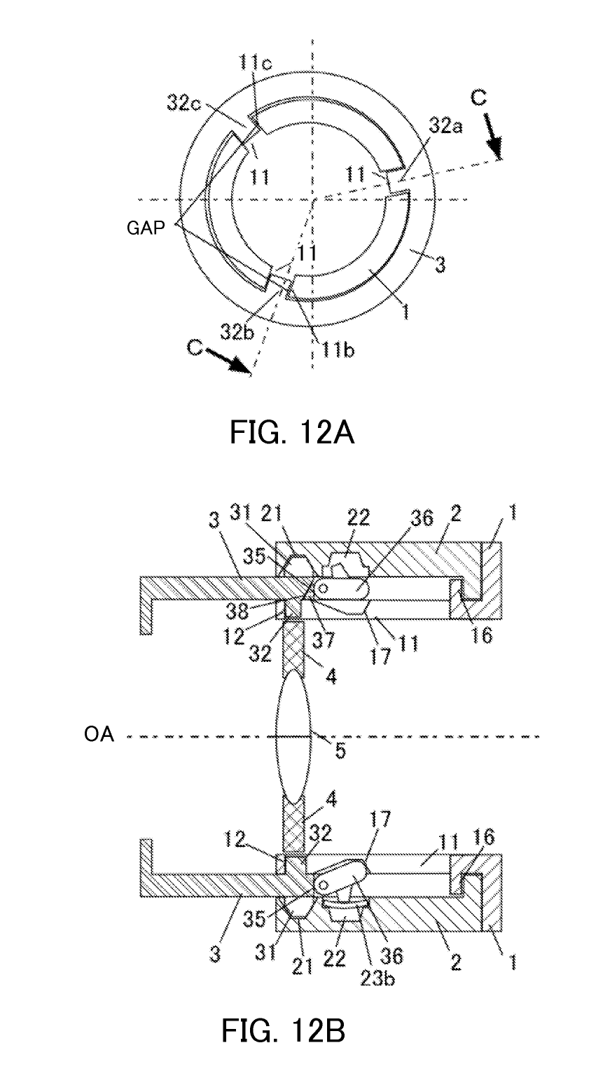

Next follows a description of performing S211 after S212 illustrated in FIG. 10B. FIGS. 12A and 12B illustrate a state resulting from completing S212 without performing S211 illustrated in FIG. 10B.

FIG. 12A is a cross-sectional view of the linear movement key. The linear movement keys 32b and 32c are not pushed onto the walls 11b and 11c, thereby generating gaps and hence the decentering of the linear movement barrel 3 relative to the fixed barrel 1 in the plane orthogonal to the optical axis.

FIG. 12B is a sectional view along line C-C in FIG. 12A. The linear movement keys 32b and 32c are pushed onto the second contact surface 12 without gaps. Although not illustrated in FIG. 12B, the linear movement key 32c is in the same state as the linear movement key 32b. Since the linear movement keys 32b and 32c are pushed, there are little gaps between the linear movement key 32a and the second contact surface 12. This indicates that the tilt of the linear movement barrel 3 relative to the fixed barrel 1 in the optical axis is adjusted.

The decentering is adjusted at the next step. The leaf spring 23a, not illustrated in FIGS. 12A and 12B, acts on the wedge 36 so as to adjust the decentering in the plane orthogonal to the optical axis through the force dividing block 37. However, the linear movement keys 32b and 32c are already pushed onto the second contact surface 12. Although a pushing force generated at the force dividing block 37 disposed near the linear movement key 32a acts to adjust the decentering, frictional forces generated near the linear movement keys 32b and 32c block the decentering adjustment. It is thus difficult to adjust the tilt first and then adjust the decentering.

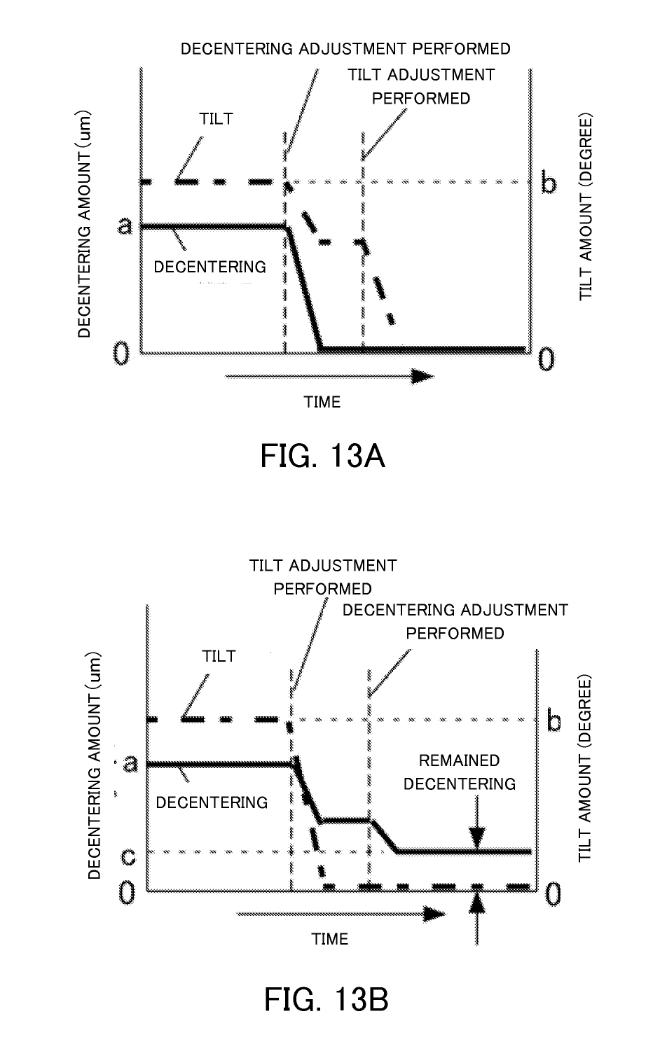

FIGS. 13A and 13B are graphs of the amount of remained decentering that depends on the order of the decentering adjustment and the tilt adjustment. The horizontal axis represents time, and vertical dashed lines represent times at which the decentering adjustment and the tilt adjustment are performed. When the decentering adjustment is performed first as in this embodiment, as illustrated in FIG. 13A, the amounts of the decentering and the tilt are substantially zero after the tilt adjustment. On the other hand, when the tilt adjustment is performed first, as illustrated in FIG. 13B, some decentering remains unadjusted because the frictional forces block the decentering adjustment as described above.

This problem can be solved by reducing the frictional force between the second contact surface 12 and the linear movement key 32 or by using the leaf spring 23a having an elastic force twice or more of that of the leaf springs 23b and 23c. However, these methods respectively require surface processing to reduce the frictional force between the second contact surface 12 and the linear movement key 32, and forming of the leaf spring 23a in a separate process from the leaf springs 23b and 23c, which complicates a manufacturing process and hence increases the cost. Thus, the configuration in this embodiment is preferable.

As described above, the accuracies of the decentering adjustment and tilt adjustment can be improved by performing the decentering adjustment first and then performing the tilt adjustment rather than performing the tilt adjustment first and then performing the decentering adjustment. Thus, the accuracies of the relative decentering and tilt between a plurality of guides can be maintained when the lens barrel including the guides that guide a plurality of lenses relatively movable in the optical axis direction is in the photographing state.

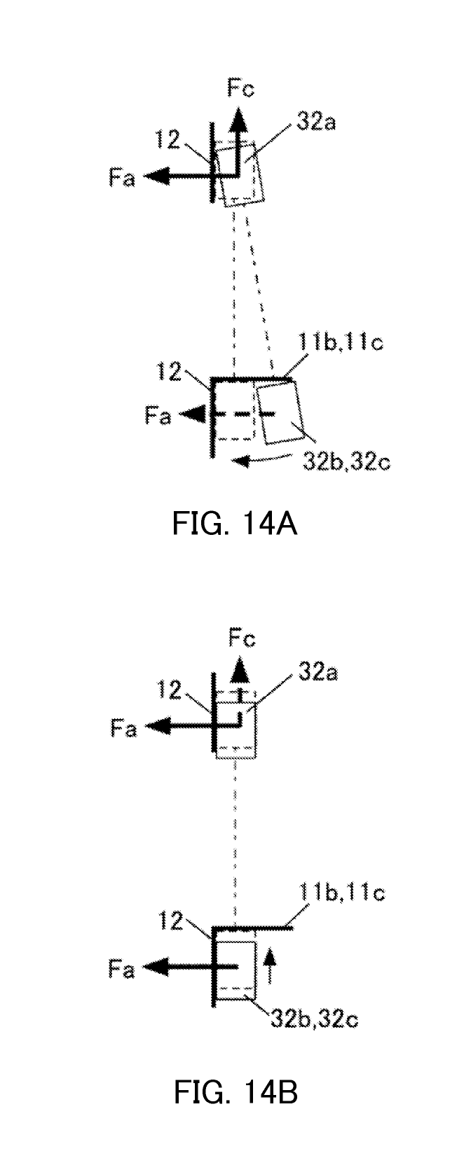

FIG. 14A is a schematic sectional view illustrating the relationship between the linear movement key 32 and the second contact surface 12, and includes the optical axis. At S211, as illustrated by solid lines in FIG. 14A, the forces Fa and Fc act only on the linear movement key 32a, and at S212, the force Fa also acts on the linear movement keys 32b and 32c so that the linear movement keys 32b and 32c are moved clockwise in the sheet of the figure and pushed onto the second contact surface 12. In this state, since the linear movement keys 32b and 32c are pushed onto the walls 11b and 11c, the frictional forces are generated and block the pushing onto the second contact surface 12.

However, since the clockwise rotation is a movement in a direction of departing away from the walls 11b and 11c, the pushing onto a third contact surface 12 can be performed relatively smoothly. Although FIG. 14A illustrates the amount of the movement larger than an actual movement for description purpose, the separation of the linear movement keys 32b and 32c at the operation at S211 is small in the actual movement because the force Fa acts on the linear movement key 32a.

Next follows a description of disadvantages of the decentering adjustment after the tilt adjustment with reference to FIG. 14B. In this case, as illustrated with solid lines in FIG. 14B, the force Fa acts on the three linear movement keys 32. Although the pushing onto the second contact surface 12 is completed, the pushing onto the walls 11b and 11c is not performed. The frictional force generated by the pushing onto the second contact surface 12 blocks the pushing onto the walls 11b and 11c by the force Fc, and thus the force Fc larger than the force Fa is required to perform the decentering adjustment in this state. An insufficient force Fc results in an insufficient accuracy of the decentering adjustment. Therefore, the configuration in this embodiment is preferable.

This problem can be solved by reducing the frictional force between the second contact surface 12 and the linear movement key 32 or by using the leaf spring 23a having an elastic force twice or more of that of the leaf springs 23b and 23c. However, these methods respectively require surface processing to reduce the frictional force between the second contact surface 12 and the linear movement key 32, and forming of the leaf spring 23a in a separate process from the leaf springs 23b and 23c, which complicates a manufacturing process and hence increases the cost. Thus, the configuration in this embodiment is preferable.

As described above, the force amplification by the wedge 36 enables the optical performance of the optical element to be maintained without increasing a driving load on the holder of the optical element while maintaining the accuracy of adjusting at least one of decentering and a tilt, even if a user unintentionally touches the linear movement barrel 3.

The above embodiment provides a retractable lens barrel and an image pickup apparatus that are capable of maintaining the accuracies of adjusting decentering and a tilt between two guides that guide a holder of an optical element, thereby maintaining a predetermined optical performance of the optical element. The embodiment also provides a retractable lens barrel and an image pickup apparatus that are capable of maintaining the accuracy of adjusting at least one of decentering and a tilt without increasing a driving load on a holder of an optical element.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-212222, filed Oct. 9, 2013, and Japanese Patent Application No. 2013-212195, filed Oct. 9, 2013, which are hereby incorporated by reference herein in their entirety.

What is claimed is:

1. A the lens barrel comprising;
a first guide;
a second guide configured to protrude toward an object relative to the first guide in an optical axis direction in a transition from a retracted state to a photographing state;
a lens holding unit having one holder held by the first guide and another holder held by the second guide;
a shift adjuster configured to adjust a shift between the first guide and the second guide in a direction orthogonal to the optical axis in the photographing state;
a tilt adjuster configured to adjust a tilt between the first guide and the second guide in the photographing state; and
a lock member configured to determine a positional relationship between the first guide and the second guide after the shift adjustment and the tilt adjustment.

2. The lens barrel according to claim 1, wherein the tilt adjustment is performed after the shift adjustment.

3. The lens barrel according to claim 1,
wherein the plurality of tilt adjusters are provided at positions having different phases in a circumferential direction of the lens barrel, and
wherein a power point position of the tilt adjustment performed first is closer to a power point position of the shift adjustment than a power point position of the tilt adjustment performed next is.

4. The lens barrel according to claim 1, further comprising a cam ring including: a fixed lens barrel holding the first guide, a linear movement barrel holding the second guide, and a cam groove, the cam ring being provided to the fixed lens barrel rotatably around the optical axis,
wherein the linear movement barrel includes a cam follower configured to move along the cam groove, and
wherein the cam follower moves along the cam groove and the linear movement barrel moves relative to the fixed lens barrel in the optical axis direction when the cam ring rotates relative to the fixed lens barrel.

5. The lens barrel according to claim 1,
wherein the fixed lens barrel includes a first groove and a second groove extending in the optical axis direction,
wherein the linear movement barrel includes a first linear movement portion configured to move along the first groove of the fixed lens barrel and a second linear movement portion configured to move along the second groove, and
wherein the shift adjuster moves the second linear movement portion to a sidewall of the second groove by applying a force having a component in the direction orthogonal to the optical axis to the first linear movement portion.

6. The lens barrel according to claim 5, wherein the tilt adjuster makes the first linear movement portion contact with a first surface of the first groove and orthogonal to the optical axis and makes the second linear movement portion contact with a second surface of the second groove and orthogonal to the optical axis.

7. The lens barrel according to claim 6, further comprising:
a first forcing member configured to push the first linear movement portion onto the first surface in a direction departing from the optical axis; and
a second forcing member configured to push the second linear movement portion onto the second surface,
wherein the first forcing member serves as the shift adjuster and the tilt adjuster,
wherein the second forcing member serves as the tilt adjuster, and
wherein when the cam ring rotates, the first forcing member starts pushing the first linear movement portion onto the first surface in the direction orthogonal to the optical axis before the second forcing member pushes the second linear movement portion onto the second surface, and the second forcing member pushes the second linear movement portion onto the second surface while the first forcing member is pushing.

8. The lens barrel according to claim 7, wherein the first forcing member and the second forcing member are leaf springs, and the first forcing member has a wider width than second forcing member in a circumferential direction of the cam ring.

9. The lens barrel according to claim 7, further comprising a force dividing block provided to the first groove, having the first surface, and configured to divide a force on the first surface into a force in a direction vertical to the optical axis and a force in the optical axis direction.

10. An image pickup apparatus comprising a lens barrel, wherein the lens barrel includes:
a first guide;
a second guide configured to protrude toward an object relative to the first guide in an optical axis direction in a transition from a retracted state to a photographing state;
a lens holding unit having one holder held by the first guide and another holder held by the second guide;
a shift adjuster configured to adjust a shift between the first guide and the second guide in a direction orthogonal to the optical axis in the photographing state;
a tilt adjuster configured to adjust a tilt between the first guide and the second guide in the photographing state; and
a positioner configured to position the first guide and the second guide after the shift adjustment and the tilt adjustment.

11. A lens barrel comprising:
a first guide;
a second guide configured to protrude toward an object relative to the first guide in an optical axis direction in a transition from a retracted state to a photographing state;
a lens holding unit having one holder held by the first guide and another holder held by the second guide;
a lock member configured to determine a positional relationship between the first guide and the second guide; and
a forcing member,
wherein the lock member pushes a lens barrel holding the second guide by a force larger than a force applied by the forcing member in the photographing state.

12. The lens barrel according to claim 11, wherein a direction in which the forcing member pushes the lock member differs from a direction in which the lock member pushes the lens barrel holding the second guide.

13. The lens barrel according to claim 11, wherein the lock member applies, to the lens barrel holding the second guide, the force larger than force applied by the forcing member, and determines a position of the second guide relative to the first guide.

14. The lens barrel according to claim 11,
wherein a lens barrel holding the first guide includes a groove extending in the optical axis direction,
wherein a force dividing block disposed on the groove is provided to a surface at which the lock member pushes the lens barrel holding the second guide,
wherein the force dividing block divides a force on the surface at which the lock member pushes the lens barrel holding the second guide into a force Fc in a direction vertical to the optical axis and the force in the optical axis direction that pushes the lens barrel holding the second guide and determines a position of the second guide relative to the first guide, and
wherein the force Fc in the direction vertical to the optical axis adjusts decentering of the second guide relative to the first guide in the direction vertical to the optical axis.

15. The lens barrel according to claim 14, further comprising:
a cam ring including a cam groove and provided rotatably around the optical axis to the lens barrel holding the first guide; and
a cam follower configured to move the lens barrel holding the second guide along the cam groove,
wherein the lock member includes a protrusion to which the forcing member applies the force,
wherein the lock member is movable between a first position at which the lock member is pushed by the forcing member and in contact with the lens barrel holding the first guide and a second position at which the lock member is not pushed by the forcing member and not in contact with the lens barrel holding the first guide, and
wherein the cam ring includes a groove into which the protrusion is inserted when the lock member is at the second position.

16. An image pickup apparatus comprising a lens barrel, wherein the lens barrel includes:
a first guide;
a second guide configured to protrude toward an object relative to the first guide in an optical axis direction in a transition from a retracted state to a photographing state;
a lens holding unit having one holder held by the first guide and another holder held by the second guide;
a lock member configured to determine a positional relationship between the first guide and the second guide, and
a forcing member,
wherein the lock member pushes the lens barrel holding the second guide by a force larger than a force applied by the forcing member in the photographing state.
